(19) United States
(12) Patent Application Publication
(10) Pub. No.: US 2025/0155274 A1
(43) Pub. Date: May 15, 2025

(54) METHOD FOR DETERMINING RELIABILITY OF A WEIGHING RESULT, COMPUTER-READABLE MEDIUM, AND SYSTEM

(71) Applicants: Mettler-Toledo (Changzhou) Measurement Technology Ltd., Changzhou (CN); Mettler-Toledo (Changzhou) Precision Instruments Ltd., Changzhou (CN); Mettler-Toledo International Trading (Shanghai) Co., Ltd., Shanghai (CN)

(72) Inventors: Yong Yang, Changzhou (CN); Kejing Huang, Changzhou (CN); ShenJian Qian, Changzhou (CN); Xiaoming Zhuang, Changzhou (CN); Xuyang Wang, Changzhou (CN); Bo Shen, Changzhou (CN)

(21) Appl. No.: 18/839,986

(22) PCT Filed: Feb. 22, 2023
(86) PCT No.: PCT/CN2023/077676

§ 371 Date: Aug. 20, 2024

(30) Foreign Application Priority Data
Feb. 22, 2022 (CN) 202210160214.X

(51) Int. Cl. G01G 23/01; G01G 23/44

(52) U.S. Cl. CPC G01G 23/01; G01G 23/44

(57) ABSTRACT

A method for determining the reliability of a weighing result, a computer-readable medium, and a related system are disclosed. The method for determining the reliability of a weighing result includes: using an AI classification algorithm trained by data including event data related to a weight system and weighing data obtained by a sensor thereof, and making an inference about a weighing result, including providing latest data obtained by the same weighting system or a weigh system of a same kind to the AI classification algorithm, including latest event data and latest weighing data representing the weighing result. The method, the computer-readable medium, and the system disclosed herewith determine whether a weighing system is operating normally and whether displayed data is reliable.

### TECHNICAL FIELD

The present invention relates to the technical field of resistive strain weighing and measurement, and in particular to a method, applicable to a weighing system, for sensing the reliability of a weighing result, a computer-readable medium, and a related system.

### BACKGROUND ART

A conventional weighing system uses a signal detection technology, an additional sensor, and an instrument software algorithm to detect an anomaly of the weighing system, and displays an anomaly alarm information to a user via a terminal interface. The signal detection and the software algorithm are applicable only to limited scenarios. In the case that the weighing system itself is operating normally, it is impossible to detect hidden factors that interfere with weighing, and it is impossible to know whether currently displayed weighing data is accurate. In addition, additional sensors increase the cost and complexity of the weighing system.

### SUMMARY OF INVENTION

In view of the above problems in the prior art, the present invention proposes a method, applicable to a weighing system, for determining the reliability of a weighing result, a computer-readable medium, and a system for determining the reliability, configured to determine whether a weighing system works normal and whether data displayed are reliable.

Specifically, the present invention proposes a method for determining a reliability of a weighing result of a weighing system, wherein the method comprises:
A step of providing data, wherein the step of providing data comprises:
   A step of providing event data related to the weighing system and of providing weighing data that are obtained by a sensor of the weighing system.
      In particular, the weighing data may be obtained, this means acquired, during the event. In particular, the weighing data may represent a weighing result before, in particular at least some time immediately before, during, and after, in particular at least some time immediately after, the event.
      Usually, the weighing data and the event data are provided in a time-dependent manner. For example, the weighing data may be provided as a function of time and the event data may be provided as a log file, in particular by providing an identifier for each event that happens and an identifier for the time at which the event occurred.
      The step of providing may be or comprise a step of uploading. The step of providing may be or comprise a step of uploading in particular if the method is applied in the context of the Internet of things (IoT).
      The provided, for example uploaded, data are usually data of a weighing system that operates normally, for example by the data being generated immediately after installation, revision and/or approval of the weighing system.
   A step of storing the data in a database.
A step of training an Artificial Intelligence (AI) classification algorithm, also called, for example, AI engine for classification or AI for classification, using the data, wherein the step of training comprises:
   A step of pre-processing the data. The step of pre-processing may comprise co-registration, in particular if the step of providing data is carried out a plurality of time and/or if the data provided comprises a plurality of sets of event data and weighing data.
   A step of performing feature identification on the data.
      For example, the data, in particular the weighing data, may be screened for at least one of the following features:
         Noise, a slope associated with an event, and/or constancy of the time-dependent weighing data in the absence of an event.
         A data point representing the start of an event, in particular an event given in the event data, a data point representing the end of an event, a data point representing the start of a subsequent event, in particular a subsequent event given in the event data, data point(s) representing a stable state of the weighing system, in particular after an event, a data point representing a beginning of a stable state of the weighing system, in particular after an event.
      In particular, the step of performing feature identification may comprise or be a step of feature recognition.
      The step of performing feature identification may be an automated step.
   A step of exporting a trained model of the AI classification algorithm.
      The model may be made available via an API. In other words, the model may be exported according to or to or as an API.
      The model may be optimal, in particular optimal for a specific weighing system.
   The artificial Intelligence classification algorithm that is trained in the step of training an Artificial Intelligence (AI) classification algorithm may be provided by a cloud server.
   It goes without saying that the step of training an Artificial Intelligence (AI) classification algorithm, in the sense of the present invention, comprises a step of classifying (“labelling”) the data, in particular the weighing data.
   In cases in which the weighing data represents a plurality of events, the step of classifying may comprise classifying a plurality of sections of the weighing data, wherein a section of the plurality of sections represents an event, in particular an event given in the event data. Each classified section of the plurality of section may then be used as a separate element of the training data, or validation data or test data, as the case may be.
   In a preferred embodiment, the step of classifying the weighing data comprises classification into one of the two categories “normal operation of the weighing system” and “anormal operation of the weighing system”.
A step of making inference, in particular real-time inference, about a weighing result, this means of assessing a weighing result, in particular assessing in real-time, wherein the step of making inference comprises:
   A step of providing latest data obtained by the weighing system, wherein the latest data comprise latest event data and latest weighing data representing the weighing result.
      The latest data may be of the same kind and/or may comprise information of the same kind as the data provided in the step of providing data.
   A step of using the trained model exported in the step of exporting a trained model for determining the reliability of the weighing result.
   In particular, the reliability of the weighing result is determined by determining whether the weighing data is anomalous.
   The latest data may be the latest data of the very same weighing system that provided, in particular generated, the data provided in the step of providing data.
   Alternatively, the data provided in the step of providing data may be or may also be provided, in particular generated, by at least one weighing system that is of the same kind (type) as the weighing system that provides the latest data but that is not the weighing system that provides the latest data. “May also be provided by” means that a plurality of weighing systems of the same kind (type), for example the weighing system that provides the latest data and the at least one weighing system that is not the weighing system that provides the latest data, may provide, in particular generate, the data provided in the step of providing data.
   The term “latest” is used to distinguish the data assessed by using the trained model from the data used to train an AI classification algorithm for generating the trained model. However, the term “latest” does not imply necessarily that a real-time assessment is carried out. Rather, it is also possible that the assessment is carried out with a considerable time delay.

At least one of a grid search and cross validation method may be used in the method, for example in the step of training an Artificial Intelligence classification algorithm.

According to an embodiment, the step of making inference comprises a step of performing feature identification on the latest data, in particular on the latest weighing data.

The step of performing feature identification on the latest data may be according to any embodiment of the step of performing feature identification that is carried out in the step of training an AI classification algorithm. In particular, the latest data, in particular the latest weighing data, may be screened for the same features.

In particular, the latest data, in particular the latest weighing data, may be screened for features that allow to identify a section of the weighing data that represents an event, in particular an event given in the event data. In other words, the step of performing feature identification on the latest data, in particular on the latest weighing data, may comprise or be a step of feature recognition.

The step of performing feature identification on the latest data may be an automated step.

In an embodiment, the step of making inference about a weighing result comprises making inference about a result of the feature identification, in particular about said section.

According to an embodiment, the trained model is made available, this means provided, via an API, as indicated above, and the step of making inference comprise calling the API.

In particular, the API may be called to make real-time inference, for example real-time inference about a result of the performed feature identification.

According to an embodiment, the event data provided in at least one of the step of providing event data related to the weighing system and of providing weighing data, and the step of providing latest data includes at least one of an operation event, a weight change event, and a network event. The operation event may include an operation such as zeroing or taring, for example, The network event may include an online or offline operation, for example.

According to an embodiment of the present invention, the step of training an AI classification algorithm includes:
A step of performing feature selection on the data to create a data set, and dividing the data set into a training set, a validation set, and a test set, for example according to a random sampling method.
   The step of performing feature selection may be or comprise a step of selecting at least one section of the weighing data, wherein a section of the at least one section represents an event, in particular an event given in the event data, and is classified (labelled), in particular classified into one of the two categories “normal operation of the weighing system” and “anormal operation of the weighing system”.
A step of training a plurality of classification algorithms using the data set, and selecting, from training results, the model of the classification algorithm (also called “algorithm model”) with the best performance on the test set.
   The plurality of classification algorithms may be provided by a cloud server.
A step of saving a model file of the algorithm model with the best performance.
   The model file may be saved such that it is available via an API. In other words, the model may be saved according to or to or to generate as a/the API.

According to an embodiment of the present invention, in the step of providing event data related to the weighing system and of providing weighing data, the weighing system is connected to a cloud server via a network, and the weighing data obtained by the sensor and the event data are uploaded to the cloud server.

In particular, the weighing data obtained by the sensor are uploaded to the cloud server through TCP protocol, and the event data are uploaded to the cloud server through MQTT protocol.

Alternatively or in addition, in the step of storing the data, the provided weighing data and event data are stored and indexed on the cloud server using at least one of a structured database, a NoSQL database, and a time series database.

According to an embodiment of the present invention, before step of training an AI classification algorithm according to any embodiment is performed, a filtering operation is performed on the provided data to remove data that are influenced by events that are not inherent in the weighing system (also called “anomalous data”). People that influence the weighing system by their behaviour, for example by walking around, are an example of an event that is not inherent in the weighing system.

The same filtering operation may be applied to the provided latest data.

According to an embodiment of the present invention, the pre-processing carried out in the step of pre-processing includes normalizing the provided data.

In addition, the latest data provided in the step of providing latest data may be pre-processed, in particular normalized, as well. In particular, the latest data and the data may be pre-processed, in particular normalized, in the same manner.

In particular, the data and, as the case may be, the latest data may be co-registered.

In embodiments comprising the step of training a plurality of classification algorithms and of selecting the model of the classification algorithm with the best performance on the test set, a plurality of classification algorithms may be prefabricated and a grid search and cross validation method may be used, in particular in said step.

Alternatively or in addition, the plurality of classification algorithms includes at least two of a logistic regression classification algorithm, a support vector machine classification algorithm, a linear classification algorithm, and a gradient boosted decision tree classification algorithm. In an embodiment, the plurality of classification algorithms includes a logistic regression classification algorithm, a support vector machine classification algorithm, a linear classification algorithm, and a gradient boosted decision tree classification algorithm.

Alternatively or in addition, in the step of training a plurality of classification algorithms and of selecting the model of the classification algorithm with the best performance on the test set, a threshold may be set, and the plurality of classification algorithms is traversed; if an accuracy of an algorithm model generated by one of the plurality of classification algorithms is higher than the threshold, this algorithm model of the classification algorithm is used as the algorithm model with the best performance; and if an accuracy of an algorithm model generated by one the plurality of classification algorithms is not higher than the threshold, the method returns to the step of performing feature selection on the data to create a data set and of dividing the data set.

After returning to the step of preforming feature selection, a classification algorithm of the plurality of classification algorithms that is different from the classification algorithm that generated the algorithm model having an accuracy not higher than the threshold may be selected.

Alternatively or in addition, after returning to the step of preforming feature selection, the step of performing feature selection may be carried out again.

Alternatively or in addition, after returning to the step of preforming feature selection, additional data and/or updated data representing further events may be considered.

In addition or alternatively, the manner the data set is divided into a training set, a validation set, and a test set training data may be modified.

The present invention further provides a computer-readable medium having computer instructions stored thereon, where when the computer instructions are executed, the steps of the method for determining reliability of a weighing result according to any one of the foregoing embodiments are performed.

The present invention further provides a system, in particular a system being or comprising a weighing system, including a memory and a processor, the memory storing computer instructions executable on the processor, where when the processor executes the computer instructions, the steps of the method for determining reliability of a weighing result according to any one of the foregoing embodiments are performed.

Elements of the system may be arranged remote from other elements of the system.

According to the method, the computer-readable medium and the system provided by the present invention are configured to determine whether a weighing system operates normally and whether data displayed is reliable.

It should be understood that the above general description and the following detailed description of the present invention are both exemplary and illustrative, and are intended to provide further explanations for the present invention.

### BRIEF DESCRIPTION OF DRAWINGS

The accompanying drawings are included to provide a further understanding of the present invention and are incorporated in and constitute a part of the present application, show the embodiments of the present invention, and serve to, together with the description, explain the principles of the present invention. In the accompanying drawings:

FIG. 1 is a flowchart of a method for determining reliability of a weighing result according to an embodiment of the present invention;

FIG. 2 is a schematic visualization of exemplary embodiments of features used in exemplary embodiments of methods according to the present invention;

FIG. 3 is a schematic visualization of an exemplary embodiment of event data; and

FIG. 4 is a schematic visualization of an exemplary system configured to carry out embodiments of the present invention.

### DESCRIPTION OF EMBODIMENTS

It should be noted that, in the case of no conflict, the embodiments and the features thereof in the present application can be combined with each other.

The technical solutions of the present application will be clearly and completely described below in conjunction with the drawings in the embodiments of the present application. Apparently, the described embodiments are merely some rather than all the embodiments of the present application. The following description of at least one exemplary embodiment is merely illustrative, and in no way serves as any limitation on the present application and application or use thereof. All other embodiments derived by those of ordinary skill in the art based on the embodiments of the present application without creative efforts fall within the protection scope of the present application.

It should be noted that the terms used herein are merely for describing specific implementations, and are not intended to limit the exemplary implementations according to the present application. As used herein, unless the context clearly indicates otherwise, the singular forms are intended to include the plural forms as well. Moreover, it should also be understood that when the terms “include(s)” and/or “comprise(s)” are used in the description, it indicates the presence of features, steps, operations, devices, components, and/or combinations thereof.

Unless specifically stated otherwise, the relative arrangement of components and steps, numerical expressions and numerical values set forth in these embodiments do not limit the scope of the present application. In addition, it should be understood that, for ease of description, the sizes of various parts shown in the drawings are not drawn to scale. The technologies, methods, and devices known to those of ordinary skill in the related art may not be discussed in detail, but where appropriate, the technologies, methods, and devices should be regarded as part of the authorization specification. In all examples shown and discussed here, any specific value should be interpreted as merely exemplary and not as limiting. Therefore, other examples of the exemplary embodiment may have different values. It should be noted that similar reference signs and letters refer to similar items in the following drawings. Therefore, once a specific item is defined in one of the drawings, it need not be further discussed in subsequent drawings.

In the description of the present application, it should be understood that an orientation or position relationship indicated by orientation terms such as “front, rear, upper, lower, left, and right”, “transverse, longitudinal, vertical, and horizontal”, and “top and bottom” is usually based on an orientation or position relationship shown in the drawings, which is only for the convenience of describing the present application and simplifying the description. Unless otherwise stated, these orientation terms do not indicate or imply that an apparatus or element referred to must have a specific orientation or be constructed and operated in a specific orientation, so that the orientation terms cannot be understood as a limitation of the protection scope of the present application; and the orientation terms “inner and outer” refer to the inside and outside relative to the contour of each component itself.

For convenience of description, spatially relative terms such as “on”, “above”, “on the top surface”, and “upper” can be used herein to describe a spatial position relationship between a device or a feature shown in the figure and other devices or features. It should be understood that spatially relative terms are intended to include different orientations in use or operation in addition to the orientation of the device described in the figure. For example, if the device in the figure is inverted, the device described as “on other devices or structures” or “above other devices or structures” will then be positioned as “under other devices or structures” or “below other devices or structures”. Therefore, the exemplary term “above” may include two orientations “above” and “below”. The device may also be positioned in other different manners (rotated by 90 degrees or in other orientations), and spatially relative description used here is explained accordingly.

In addition, it should be noted that the use of words such as “first” and “second” to define parts is merely for the convenience of distinguishing between corresponding parts. Unless otherwise stated, the above words have no special meaning and therefore cannot be understood as limitation of the protection scope of the present application. Furthermore, although the terms used in the present application are selected from well-known common terms, some of the terms mentioned in the specification of the present application may have been selected by the applicant according to his or her determination, and the detailed meaning thereof is described in the relevant section herein. Furthermore, the present application must be understood, not simply by the actual terms used but also by the meanings encompassed by each term.

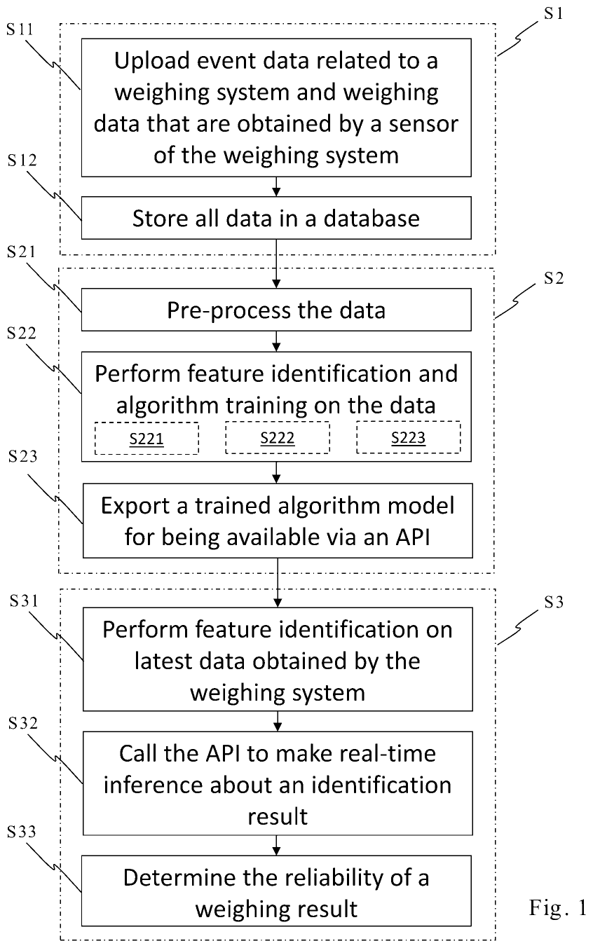

FIG. 1 is a flowchart of a method for determining the reliability of a weighing result 1 according to an embodiment of the present invention. The figure shows the method, applicable to a weighing system, for determining the reliability of a weighing result provided by the present invention. The weighing system 101, 101′, 101″ may be an electronic weighing instrument such as a bench scale, counter scale, platform scale, and truck scale. The method includes the following steps:
S1. Providing (generating, collecting etc.) data, which includes the following steps:
   S11. Uploading event data 3 related to the weighing system 101, 101′, 101″ and weighing data 4 that are obtained by a sensor 102 of the weighing system. “Event” in the event data includes an operation event 31, a weight change event 32, or a network event 33. The operation event includes an operation such as zeroing or taring. The network event includes an online or offline operation. It is easily understood that before the sensor operates, the weighing system is first powered on.
   S12. Storing all the data, including the weighing data 4 and the event data 3, in a database 103.
S2. Training an AI classification algorithm using the data, which includes the following steps:
   S21. Pre-processing the data.
   S22. Performing feature 11, 12, 21-23 identification and algorithm training on the data.
   S23. exporting a trained algorithm model for being available via an API (application programming interface, 104). For example, the trained optimal algorithm model is exported as an API 104. The exported trained algorithm model may be optimal, in particular optimal for a specific weighing system and/or for real-time inference of a weighing result 1.
S3. Making inference about a weighing result 1, which includes the following steps:
   S31. Performing feature 21-23 identification on latest data obtained by the weighing system 101. In the embodiment shown, feature identification is performed on the weighing data 4 and the event data 3 that are obtained in real time.
   S32. Calling the API 104 to make real-time inference about an identification result of step S31.
   S33. Determining the reliability of the weighing result 1, in particular by determining whether the weighing data 4 is anomalous.

Preferably, step S22 includes:
S221. Performing feature selection on the data to create a data set, and dividing the data set into a training set, a validation set, and a test set according to a random sampling method;
S222. Training a plurality of classification algorithms using the data set, and selecting, from training results, an algorithm model with the best performance on the test set; and
S223. Saving a model file of the optimal, in particular best performing, algorithm model, in particular for making it available via the API 104. For example, the model file of the optimal algorithm model is saved to generate the API 104. A Flask server program may be used to load the generated model file and provide a corresponding web API.
   The optional steps S221, S222, and S223 are indicated in FIG. 1 by dashed boxes.

Preferably, in step S11, an instrument 105 of the weighing system 101 accesses a network 107 after being powered on, and is connected to a cloud server 106 via the network. The weighing data 4 and the event data 3 obtained after filtering of A/D values of the sensor 102 are uploaded to the cloud server.

Preferably, the weighing data 4 obtained by the sensor 102 is uploaded to the cloud server 106 through the TCP protocol, and the event data 3 is uploaded to the cloud server through the MQTT protocol.

Preferably, in step S12, the uploaded weighing data and event data are stored on the cloud server 106 using a structured database, a NoSQL database, and a time series database. Different types of event data 3 are stored and correspondingly indexed using different databases. In a relational database, an index is a storage structure for sorting values of one or more columns in a database table. The index is a set of values of one or more columns in a table and a list of logical pointers that correspondingly point to data pages physically identifying these values in the table. The function of the index is equivalent to the table of contents of a book, and the desired content can be quickly found according to the page number in the table of contents. Herein, the purpose of indexing is to facilitate the subsequent search of data, which is time-efficient and especially suitable for search of massive data.

Preferably, before step S2 is performed, a filtering operation is performed on the data to remove anomalous data. For example, data in an unstable state that is formed when people are walking on a large electronic scale is filtered to remove these anomalous samples.

Preferably, in step S21, the pre-processing includes normalizing the data. Normalization herein refers to classification and regularization of the data. The regularized data is combined with timestamps to align structured and unstructured data. The structured data is the data 4 of the sensor 102, and the unstructured data is the event data 3. Alignment refers to sorting by the timestamps.

Preferably, in step S222, a plurality of classification algorithms is prefabricated and a grid search and cross validation method is used to train the data. More preferably, the classification algorithms include a logistic regression classification algorithm, a support vector machine classification algorithm, a linear classification algorithm, and a gradient boosted decision tree classification algorithm. The machine learning classification algorithms are trained using the data, with the intention of learning to distinguish between normal weighing data and anomalous weighing data, so as to obtain an optimal algorithm model.

Preferably, in step S222, a threshold is set, and the classification algorithms are traversed; if accuracy of an algorithm model generated by the classification algorithm is higher than the threshold, the algorithm model of the classification algorithm is used as the algorithm model with the best performance; and if the accuracy of the algorithm model generated by the classification algorithm is not higher than the threshold, the method returns to step S221. Specifically, in step S222, a first classification algorithm is first selected; and if accuracy of an algorithm model generated by the first classification algorithm is not higher than the threshold, then the method returns to step S221, to perform feature selection on the data again. Next, in step S222, a second classification algorithm is selected; and if accuracy of an algorithm model generated by the second classification algorithm is not higher than the threshold, then the method returns to step S221, to perform feature selection on the data again. By analogy, the resulting loop goes on until a classification algorithm is selected in step S222, this classification algorithm generating an algorithm model having an accuracy that is higher than the threshold, and the algorithm model of this classification algorithm is used as the algorithm model with the best performance.

Preferably, after step S32, a determination result is sent to a user. The determination result may be sent to the user via push message, WeChat, email, etc.

FIG. 2 is a schematic visualization of exemplary embodiments of features used in exemplary embodiments of methods according to the present invention. Weighing data 4 obtained by the sensor 102 of the weighing system 101 (“measured weighing data” in the following) are shown, wherein the measured weighing data 4 shown are time-dependent. A weighing curve that visualizes the time-dependence of the measured weighing data 4 is shown. The unit of the x-axis represents time, such as a date, e.g. dd.mm.yy hh:mm:ss, and is indicated by “t” in FIG. 2. The unit of the y-axis represents the unit of a signal measured by the sensor 102 or derived from such as signal, such as a weight, e.g. kg or lb, and is indicated by “S” in FIG. 2.

Five exemplary events 31-33 are shown. The exemplary events, in the chronological order shown, are: an operation event 31, namely a taring event, a first weight change event 32, namely loading with a weight, a second weight change event 32, namely unloading of the weight, a third weight change event 32, namely loading with another event, and a network event 33, namely offline operation.

FIG. 2 shows further a weighing curve (dashed line) that represents weighing data 5 as expected for a normally operating weighing system 101 (“expected weighing data” in the following).

In the exemplary embodiment shown, the measured weighing data 4 deviate from the expected weighing data 5 at the weight change events 32. In particular, the slope 11 of the measured weighing data 4 is not as steep as it should be and there are significant oscillations 12 before a stable weighing result 1 is achieved. In contrast to the weight change events 32, the measured weighing data 4 agrees with the expected weighing data 5 for operation event 31 and the network event 33. In other words, there is a source of disturbance that affects weight change events and the weighing result 1 that is indicated by the weighing system 101 is therefore not reliable. In other words, a significant difference between the indicated weighing result 1 and the unknown correct weighing result 2, this means the weighing result 2 of the normally operating weighing system, is expected.

The exemplary measured weighing data 4 comprise further features that are in addition to features 11, 12 indicating a source of disturbance. These further features relate to the events 31-33 themselves, and regions in which the events occurred are identified during an exemplary method for determining reliability of a weighing result that bases on measured weighing data 4 as shown in FIG. 2. Only the regions 21-23 of the first three events are shown in FIG. 2.

In embodiments of the method, these regions are used separately for training and later for making inference about a weighing result.

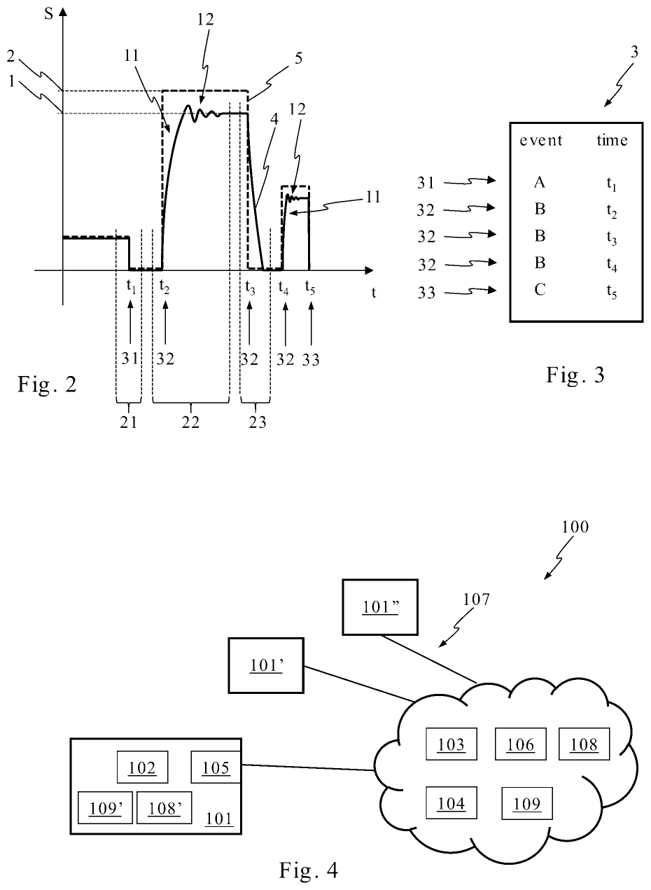

FIG. 3 is a schematic visualization of an exemplary embodiment of event data 3. In the embodiment shown, the event data 3 are provided as a log file comprising an entry for each event 31-33, wherein an entry comprises an identifier for the event and a time of occurrence of the event. For the sake of simplicity, the identifier is indicated by capital letters (A, B, C etc.) in FIG. 3. It goes without saying, that the identifier may be of any other suitable kind.

The event data 3 shown in FIG. 3 comprise the exemplary events that were attributed to the weighing data 4 of FIG. 2. In other words, the event data 3 comprise, in chronological order, the operation event 31, namely the taring event, the first weight change event 32, namely loading with a weight, the second weight change event 32, namely unloading of the weight, the third weight change event 32, namely loading with another event, and the network event 33, namely offline operation.

FIG. 4 is a schematic visualization of an exemplary embodiment of a system 100 configure to carry out embodiments of the present invention.

The system 100 shown comprises at least one weighing system 101, 101′, 101″ comprising a sensor 102 configured for generating the weighing data 4 (the latest weighing data, as the case may be), a communication unit 105 via which the weighing system can connect to a network 107, an optional memory 108′, and a processor 109′.

The system 100 shown comprises further a database 103, in particular a database that is remote from the weighing system 101, 101′, 101″, in particular a cloud database, a server 106, in particular a server that is remote from the weighing system 101, 101′, 101″, in particular a cloud server, a memory 108, in particular a memory that is remote from the weighing system 101, 101′, 101″, in particular a cloud memory, and a processor 109, in particular a processor that is remote from the weighing system 101, 101′, 101″, in particular a cloud processor, and an API 104, wherein the API is configured to give the weighing system 101, 101′, 101″ access to services provided by elements of the system 100 that are remote from the weighing system 101, 101′, 101″, in particular cloud-based.

In a cloud-based embodiment of the method, the data are uploaded via network 107 to the cloud server 106, the AI classification algorithm or, as the case may be, the plurality of AI classification algorithms, is provided by the cloud database 103 or the cloud memory 108, the trained model or, as the case may be, the model with the best performance on the test set, is generated by the cloud processor 109, and the trained model or, as the case may be, the model with the best performance on the test set is made available to the weighing system 101, 101′, 101″ via the API 104.

In summary, according to a preferred embodiment of the method for determining reliability of a weighing result 4 provided by the present invention, the instrument 105 of the weighing system 101 first accesses the network 107, uploads the weighing data 4 and the event data 3 obtained after filtering of the A/D values of the sensor 102 to the cloud, utilizes the machine learning classification algorithms to train them to distinguish between normal weighing data and anomalous weighing data to obtain an optimal algorithm model, and then utilizes the algorithm model to make inference about newly (latest, actual) uploaded data; that is, a probability threshold is set, and a comparison with the probability threshold is made, so as to obtain a probability that the current weighing system is operating normally, and determine whether the current weighing system is operating normally. This method is in particular applicable to the following cases:
1. Granary weighing: If there is a gap at the bottom of a body of a bench scale or a platform scale placed in a fixed place in a granary, grain particles easily fall into the gap. Due to immobility of the scale body, a hygienic blind spot may form at the bottom of the scale body, which is difficult to clean. Over time, the grain particles accumulated at the bottom of the weighing platform may germinate under certain environmental conditions. When they grow to a certain extent, the tip of the buds will reach the weighing platform, thus forming an upward supporting force on the weighing platform. At this time, the weighing data will become inaccurate, which can hardly be noticed by people. With the method provided by the present invention, the weighing system may access the Internet and connect to the cloud, whereupon all the steps of step S1 of providing data to step S3 of making inference may be performed, and the algorithm model can be used to distinguish the sensor data in a situation with supporting force from the sensor data in a situation without supporting force, so that whether there is an environmental factor affecting the weighing can be intelligently determined.
2. There may be hidden foreign objects in the scale body, such as small animals (such as mice, cockroaches, etc.) crawling into the scale body, stuck between the upper and lower scale bodies and unable to come out again, which affects accurate measurement of the force acting on the sensor of the weighing system and makes the weighing data inaccurate.
3. Water may enter the foundation pit of the scale body. Large electronic scales (such as truck scales) are usually buried in the foundation pit under the earth's surface. If the foundation pit is not well drained, waterlogging easily occurs in the pit during the rainy season. At this time, the weighing platform will be affected by the buoyancy of the water, making the weighing result inaccurate.
4. Deliberate cheating: In order to gain illegitimate interests, some criminals deliberately insert foreign objects into the scale body, so that the weighing data displayed on the scale is lighter than the actual weight.

The present invention further provides a computer-readable storage medium, which is a non-volatile storage medium or a non-transitory storage medium and has computer instructions stored thereon, where when the computer instructions are executed, the steps corresponding to any one of the foregoing methods for determining reliability of a weighing result are performed.

The present invention further provides a system 100, including a memory 108, 108′ and a processor 109, 109′, the memory storing computer instructions executable on the processor, where when the processor executes the computer instructions, the steps of any one of the foregoing methods for determining reliability of a weighing result are performed.

For specific implementations and technical effects of both the system and the computer-readable storage medium, reference may be made to the foregoing embodiment of the method for determining reliability of a weighing result provided by the present invention, and details are not repeated herein.

Some aspects of the method for determining reliability of a weighing result of the present invention may be completely executed by hardware, or may be completely executed by software (including firmware, resident software, microcode, etc.), or may be executed by a combination of hardware and software. The hardware or software described above may all be referred to as “data block”, “module”, “engine”, “unit”, “component”, or “system”. The processor may be one or more application-specific integrated circuits (ASIC), digital signal processors (DSP), digital signal processing devices (DSPD), programmable logic devices (PLD), field-programmable gate arrays (FPGA), processors, controllers, microcontrollers, microprocessors, or a combination thereof. In addition, various aspects of the present application may be embodied as a computer product in one or more computer-readable media, and the product includes computer-readable program code. For example, the computer-readable media may include, but are not limited to, a magnetic storage device (for example, a hard disk, a floppy disk, a tape . . . ), an optical disc (for example, a compact disc (CD), a digital versatile disc (DVD) . . . ), a smart card, and a flash memory device (for example, a card, a stick, a key drive . . . ).

The computer-readable medium may include a propagation data signal containing computer program code, for example, on a baseband or as a part of a carrier. The propagation signal may take various forms, including an electromagnetic form, an optical form, etc., or a suitable combination form. The computer-readable medium may be any computer-readable medium other than a computer-readable storage medium. The medium may be connected to an instruction execution system, apparatus, or device to implement communication, propagation, or transmission of a program for use. The program code located on the computer-readable medium can be propagated through any suitable medium, including radio, a cable, a fiber-optic cable, a radio frequency signal, or a similar medium, or any combination of the foregoing media.

In addition, unless explicitly stated in the claims, the order of processing elements and sequences, the use of numbers and letters, or the use of other names in the present application are not intended to limit the order of the procedures and methods of the present application. Some of the embodiments of the present invention that are currently considered useful have been discussed in the foregoing disclosure by various examples. However, it should be understood that such details are merely for the purpose of illustration, and the appended claims are not limited to the disclosed embodiments, but are intended to encompass all modifications and equivalent combinations that comply with the essence and scope of the embodiments of the present application. For example, although the system components described above can be implemented by hardware devices, they can also be implemented purely by software solutions, for example, installing the described system on an existing server or mobile device.

Similarly, it should be noted that, in order to simplify the disclosure of the present application to facilitate the understanding of one or more embodiments of the present application, in the foregoing description of the embodiments of the present application, various features may be sometimes incorporated into one embodiment, drawing, or the description thereof. However, such a method disclosed does not mean that the subject of the present application requires more features than those mentioned in the claims. In fact, the features of the embodiments are fewer than all the features of a single embodiment disclosed above.

In some embodiments, numbers for describing the number of compositions and attributes are used. It should be understood that such numbers used in the description of the embodiments are modified by the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the specification and claims are approximate values, and the approximate values can be changed according to the required characteristics of individual embodiments. In some embodiments, for the numerical parameters, the specified significant digits should be taken into consideration and a general digit reservation method should be used. Although the numerical ranges and parameters used to confirm the breadth of the ranges of the numerical parameters in some embodiments of the present application are approximate values, such numerical values need to be set as precisely as possible within a feasible range in specific embodiments.

It can be apparent to persons skilled in the art that various modifications and variations may be made to the exemplary embodiments of the present invention without departing from the spirit and scope of the present invention. Therefore, it is intended that the present invention covers the modifications and variations of the present invention that fall within the scope of the appended claims and their equivalents.

### LIST OF REFERENCE SIGNS

1 Weighing result
2 Weighing result of normally operating weighing system
3 Event data
4 Weighing data, latest weighing data
5 Weighing data expected for a normally operating weighing system
11 Slope of measured weighing data
12 Oscillations
21-23 Regions in which an event occurred
31 Operation event
32 Weight change event
33 Network event
100 System
101, 101′, 101″ Weighing system
102 Sensor of the weighing system
103 Database
104 API
105 Communication unit
106 Cloud server
107 Network
108, 108′ Memory
109, 109′ Processor

1. A method for determining reliability of a weighing result, said method comprising:
using a trained model of an AI classification algorithm, the trained model being trained by providing data, comprising:
providing event data related to a weighing system and providing weighing data obtained by a sensor of the weighing system; and
storing the data in a database;
training the AI classification algorithm using the data, comprising:
pre-processing the data; and
performing feature identification on the data; and
exporting the trained model of the AI classification algorithm;
making an inference about a weighing result comprising:
providing, to the trained model, latest data obtained by the same weighing system as the weighing system used during training the trained model, or by a weighing system of a same kind, wherein the latest data comprises latest event data and latest weighing data representing the weighing result.

2. The method according to claim 1, wherein the making the inference comprises performing feature identification on the latest weighing data.

3. The method according to claim 1, wherein the trained model is provided via an API and making the inference comprises calling the API.

4. The method according to claim 1, wherein the event data and latest event data include at least one of an operation event, a weight change event, and a network event.

5. The method according to claim 1, wherein training the AI classification algorithm comprises:
performing feature selection on the data to create a data set, and dividing the data set into a training set, a validation set, and a test set;
training a plurality of classification algorithms using the data set, and selecting the model of the classification algorithm with the a best performance on the test set; and
saving a model file of the algorithm model with the best performance.

6. The method according to claim 5, wherein:
the plurality of classification algorithms is prefabricated; and p1 a grid search and cross validation method is used in the training of the plurality of classification algorithms.

7. The method according to claim 6, wherein the plurality of classification algorithms comprises at least two of a logistic regression classification algorithm, a support vector machine classification algorithm, a linear classification algorithm, and a gradient boosted decision tree classification algorithm.

8. The method according to claim 5, wherein training the plurality of classification algorithms and selecting the model of the classification algorithm with the best performance on the test set comprises:
setting a threshold, and traversing the plurality of classification algorithms where an accuracy of an algorithm model generated by one of the plurality of classification algorithms is higher than the threshold, selecting said algorithm model of the classification algorithm is used as the algorithm model with the best performance; and
where an accuracy of an algorithm model generated by one of the plurality of classification algorithms is not higher than the threshold, returning to the steps of performing feature selection on the data to create the data set and dividing the data set.

9. The method according to a claim 1, wherein:
the weighing system is, or the weighing systems are, connected to a cloud server via a network; and
the steps of providing the event related to the weighing system and providing the weighing data comprises obtaining the weighing data by the sensor(s) and uploading the event data to the cloud server.

10. The method according to claim 9, wherein:
the weighing data obtained by the sensor is uploaded to the cloud server through TCP protocol; and
the event data is uploaded to the cloud server through MQTT protocol.

11. The method according to claim 9, wherein storing the data comprises storing and indexing the weighing data and the event data on the cloud server using at least one of a structured database, a NoSQL database, and a time series database.

12. The method according to claim 1, wherein, the provided data to the AI classification algorithm is filtered to remove data influenced by events that are not inherent in the weighing system.

13. The method according to claim 1, wherein the step of pre-processing of the data comprises normalizing the data.

14. A non-transitory computer-readable medium having computer instructions stored thereon, wherein when the computer instructions are executed by a system comprising a non-transitory memory, a processor, and weighing system comprising a sensor, the method according to claim 1 is performed.

15. (canceled)

16. A method of providing a trained model of an AI classification algorithm for determining reliability of a weighing result, the method comprising:
providing data, comprising:
providing event data related to a weighing system and providing weighing data obtained by a sensor of the weighing system; and
storing the data in a database;
training the AI classification algorithm using the data, comprising:
pre-processing the data; and
performing feature identification on the data; and
exporting the trained model of the AI classification algorithm.

17. The method according to claim 16, wherein training the AI classification algorithm comprises:
performing feature selection on the data to create a data set, and dividing the data set into a training set, a validation set, and a test set;
training a plurality of classification algorithms using the data set, and selecting the model of the classification algorithm with a best performance on the test set; and
saving a model file of the algorithm model with the best performance.

18. The method according to claim 16, wherein:
the weighing system is connected to a cloud server via a network; and
the steps of providing the event data related to the weighing system and providing the weighing data comprise obtaining the weighing data by the sensor and uploading the event data to the cloud server.

19. The method according to claim 16, wherein, before the step of training is performed, a filtering operation is performed on the provided data to remove data that are influenced by events that are not inherent in the weighing system.
